(19) United States
(12) Patent Application Publication
(10) Pub. No.: US 2015/0039526 A1
(43) Pub. Date: Feb. 5, 2015

(54) ONLINE MATCH-MAKING SYSTEM OR GAME, SUCH AS A WEB SITE, SMARTPHONE OR TABLET APPLICATION AND SUPPORTING NETWORK, AND CODE CONFIGURED TO PROVIDE SAME

(71) Applicant: Plymouth Rock LLC, Medford, MA (US)

(72) Inventor: Samuel W. Davidson, Medford, MA (US)

(21) Appl. No.: 14/444,729

(22) Filed: Jul. 28, 2014

Related U.S. Application Data
(60) Provisional application No. 61/860,030, filed on Jul. 30, 2013.

(51) Int. Cl. G06Q 50/00; G06F 17/30

(52) U.S. Cl. CPC G06Q 50/01; G06F 17/30867; G06F 17/30604
USPC 705/319

(57) ABSTRACT

An online match-making system, such as a smartphone or tablet application and supporting network, which is configured to promote contact between users when a mutual interest has been determined. Profiles are received from (and maintained in) a database. A user can view the different profiles, such as by viewing at least one picture associated with each profile. As the user views the different profiles or pictures, the user can indicate to the system whether or not he or she is interested in that person associated with the profile being viewed. The system keeps track of instances where a user indicates an interest in a given profile (i.e., interest in another person). When that other person logs onto the system, that other person is informed whether other users have indicated an interest, and is presented with profiles, wherein a proportion of the first plurality of profiles which are presented correspond to users who have previously indicated an interest in that person. Upon it being determined that two users have an interest in each other, the system promotes contact between the users such as by sending a message to one or preferably both of the users.

### PRIOR APPLICATION (PRIORITY CLAIM)

The present application claims priority of U.S. Provisional Application Ser. No. 61/860,030, filed Jul. 30, 2013, the entirety of which is incorporated herein by reference.

### BACKGROUND

The present invention generally relates to an online match-making system or game, and computer readable code configured to provide same.

Online dating has become more and more popular. Most people are interested in saving time and being efficient in the dating process. The traditional method of walking up to a person and trying to strike up a conversation is fraught with possible embarrassment. For example, there is a risk that you are approaching a married person, or a person that is otherwise not available. Spending time courting that person may not only turn out to be a waste of time, but it may also turn out to be embarrassing. Even if the person is single and available, the person may not be interested in you. As such, randomly walking up to someone and starting conversation is not the most efficient way to meet available people, because that person may, for example, immediately decide upon looking at you that they are not interested. Additionally, due to social constraints, there are many scenarios in life that simply do not allow you to stop and introduce yourself to someone you have never met. For example, you could pass by someone on the sidewalk periodically outside of work. Despite the fact that you find yourself attracted to that person, social constraints prevent you from speaking to them, because it is generally frowned upon in society to stop women on the sidewalk and initiate a conversation. This is despite the fact that, if you were to see them in a more social setting, it would be acceptable to approach that person and initiate a conversation.

Online dating allows people to date more efficiently because it provides a social setting where it is acceptable (and expected) to initiate contact. Additionally, online dating gives people the opportunity to pre-screen prospective dates, i.e., effectively assess them before deciding to spend precious time and energy pursuing them. There are many online dating sites currently on the Internet. These sites include Match.com, Plenty of Fish, Zoosk, eHarmony, as well as many others. These online dating sites serve their purpose. People can use them to find dates, after conducting a desired amount of pre-screening. However, these sites typically still require you to initiate contact with a person in order to determine whether that person may be interested in you.

### SUMMARY

An object of an embodiment of the present invention is to provide an online match-making system which provides that contact between two parties is promoted, once it has been confirmed by the system that there is a mutual interest between the two parties.

Briefly, an embodiment of the present invention provides an online match-making system which is configured to receive profiles from users (i.e., users submit profiles relating to themselves). The system is configured to maintain a database of the profiles which are received. Preferably, each profile includes at least a picture of the person corresponding to the profile, as well as possibly other information about the person. The system is configured such that, after a user logs onto the system, the user can view the different profiles, such as by viewing at least one picture associated with each profile. The system provides that as the user views the different profiles or pictures, the user can indicate to the system whether or not he or she is interested in that person associated with the profile being viewed. The system is configured to keep track of instances where a user indicates an interest in a given profile (i.e., interest in another person). When that other person logs onto the system, that other person is also presented with profiles, wherein a proportion of the first plurality of profiles which are presented correspond to users who have previously indicated an interest in that person. Before or while presenting the user with the plurality of profiles, the system is configured to inform the user that one or more other users have indicated an interest, but preferably does not indicate to the user exactly which users have indicated an interest. The system is configured such that upon the system confirming that two parties have indicated an interest in each other, the system promotes contact between the two parties, such as by sending one or preferably both of the parties a message informing them of the mutual interest.

Another embodiment of the present invention provides code, such as computer readable code configured for use by one or more computers or one or more computer networks, to provide an online match-making system, such as the system which was previously described. This code may include, for example, code configured to receive profiles, code configured to store the profiles in a database, code configured to present a user with a plurality of profiles for consideration, code configured to receive from the user an indication of whether or not the user has an interest with regard to each of the profiles being considered, code configured to keep track of instances where the user has indicated an interest in a given profile, code configured to present a subsequent user with a plurality of profiles for consideration wherein a proportion of the plurality of profiles which are presented to the subsequent user correspond to other users who have previously indicated an interest in the subsequent user, code configured to determine whether there exists mutual interest between users based on what the users have communicated to the system regarding profiles which were considered by the users, and code configured to indicate to the users (such as by sending one or preferably both users a message) or otherwise promote contact between two users between which the system has determined there is a mutual interest. Preferably, the code which is configured to present a subsequent user with a plurality of profiles for consideration is configured to, either before or while presenting the user with the plurality of profiles, inform the user that one or more other users have indicated an interest (such as x users in y, wherein x is a subset of y), but preferably does not indicate to the user exactly which users have indicated an interest.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a flow chart illustrating the functionality of an online match-making system which is in accordance with an embodiment of the present invention;

FIG. 2 illustrates an exemplary screen shot of the online match-making system, wherein a user is presented with another user's profile for consideration and an indication either interest or non-interest in that other user's profile;

FIG. 3 is a flow chart similar to FIG. 1, but from a user's perspective;

FIG. 4 illustrates the architecture of a exemplary network which shows one hundred users having access to the online match-making system;

FIG. 5 is a block diagram illustrating computer readable code which is in accordance with an embodiment of the present invention, wherein the code is configured to provide the online match-making system;

FIG. 6 is a flow chart which illustrates two modes of operation; and

FIG. 7 illustrates a group mode of the system.

### DESCRIPTION OF AN ILLUSTRATED EMBODIMENT

While this invention may be susceptible to embodiment in different forms, there are shown in the drawings and herein will be described in detail, specific embodiments with the understanding that the present disclosure is to be considered an exemplification of the principles of the invention, and is not intended to limit the invention to that as illustrated.

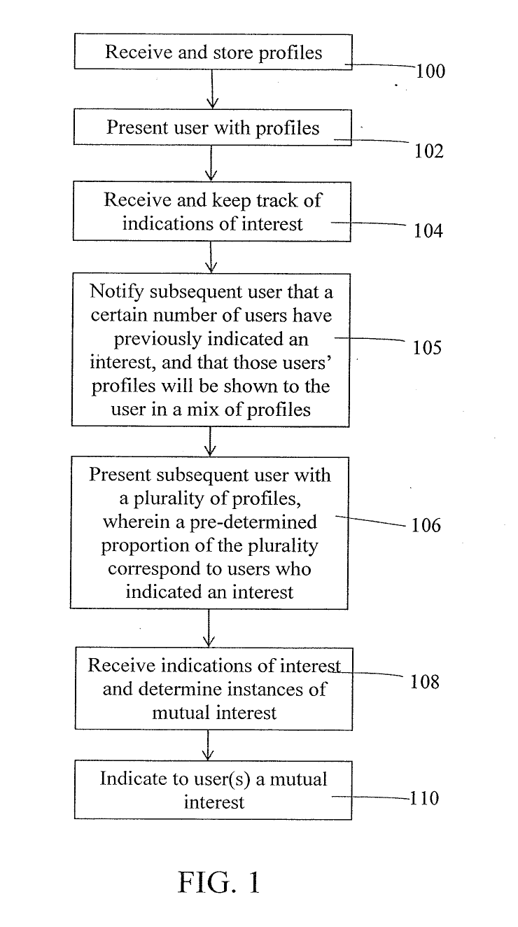

FIG. 1 provides a flow chart which illustrates the functionality of an online match-making system which is in accordance with an embodiment of the present invention. The online match-making system may take the form of, for example, a web site, a smartphone or tablet application, and a supporting network.

As shown, the system is configured to receive profiles from users and store the profiles in one or more databases (block 100 in FIG. 1). Specifically, the system provides that a user logs into the system (such as with a user name and password), and submits a profile. The profile may contain personal information about the user, but preferably includes at least one digital photograph of the user (the system is preferably configured such that a user must submit a photograph in order to proceed and view other users' photographs/profiles). The additional information contained in the profile may take many forms, but may include information about the user such as age, interests, education, etc.

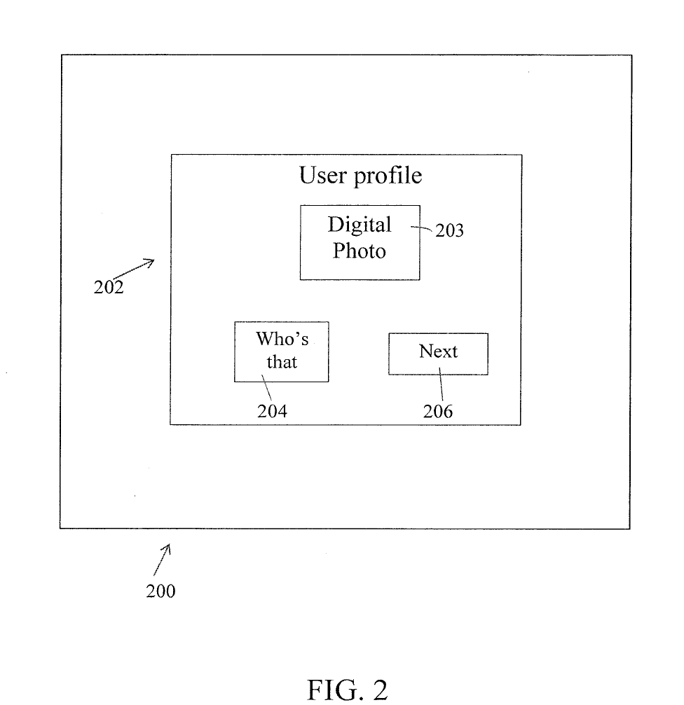

Once the user creates and submits a profile to the system, the system provides that the user is presented with profiles of other users for consideration (block 102 in FIG. 1). The system is also configured to effectively query the user whether the user is interested in the other user associated with the profile being presented. The system is configured to receive and keep track of instances where the user indicates an interest in other users (block 104 in FIG. 1). FIG. 2 provides a simplified screen shot 200 which shows a user being presented with another user's profile 202 for consideration (wherein the profile 202 preferably includes at least a digital photograph 203 of the user corresponding to that particular profile being presented). The system provides indication buttons 204, 206 on which the user can click to indicate to the system whether or not he or she has an interest in the user corresponding to the profile being presented. For example, as shown in FIG. 2, one button 204 can be clicked by the user to indicate he or she has an interest, and another button 206 can be clicked by the user indicate that he or she does not have an interest. Verbiage or indicia may be associated with each button to differentiate the buttons 204, 206 to the user. For example, as shown in FIG. 2, the system can be configured such that the user clicks “Who's That?” if he or she is interested in that user, or clicks “Next” if he or she is not interested in that user. As such, the user can flow through the profiles clicking on “Who's That?” for users in which he or she has an interest (such as after viewing the digital photograph of the user), and clicking on “Next” for users in which he or she lacks an interest. Of course, instead of “Who's That?” and “Next,” the system can be configured to present the user with different indicia or verbiage to differentiate the two buttons 204, 206 to the user. For example, instead of “Who's That?” the user can be presented with an indication of “Interested!” and instead of “Next,” the user can presented with an indication of “Not Interested!” Regardless, the system is configured to receive and keep track of instances where users have indicated an interest in other users.

As shown in FIG. 1, the system is preferably configured to provide that when a subsequent user logs into the system, if other users have indicated an interest in that subsequent user, that subsequent user is notified (block 105 in FIG. 1), and then the subsequent user is presented with a plurality of profiles, wherein a subset of the profiles correspond to the users who have previously indicated an interest (block 106 in FIG. 1). For example, when you log into the system, the system may inform you that seven users have indicated an interest in you, and that their profiles will now be shown to you mixed within the next twenty profiles to be shown to you. Seven out of twenty is just one example, and of course the system may be configured to present profiles to users in different proportions.

While the system is preferably configured such that either before or while presenting the subsequent user with the plurality of profiles, the system is configured to inform the user that one or more other users have indicated an interest (if one or more other users have, in fact, indicated an interest), the system preferably does not indicate to the user which users exactly have indicated an interest.

More specifically, the system is preferably configured to effectively operate in two modes depending on whether another user has indicated an interest in you. In one mode, no other user has indicated an interest in you since the last time you logged on and played the game. In that case, preferably the system is configured to just show you (the user) a plurality of profiles which are all randomly selected. In the other mode, one or more other users have indicated an interest in you since the last time you logged on and played the game. In that case, preferably the system is configured to notify you (the user) that x number of other users have indicated an interest in you, and that these users' profiles or pictures will be shown to you in the next y number of profiles shown (where x<y). In this case, within the first y profiles shown, x relate to users who have previously indicated an interest, and the remaining profiles (y-x) are randomly selected. Once y number of profiles are presented, the remaining profiles which are presented to the user are randomly selected by the system.

Regardless, the system is configured to present the subsequent user with profiles and effectively query the subsequent user whether or not he or she is interested in the users associated with the profiles being presented for consideration (see FIG. 2 again, for example).

The system is configured such that upon the system determining that two users have indicated an interest in each other (block 108 in FIG. 1), the system promotes contact between the two users (block 110 in FIG. 1), such as by sending one or preferably both of the users a message informing them of the mutual interest.

This process of informing the user that x number of people have indicated an interest in you, and those profiles will be shown to you within the first y profiles shown, serves as an incentive or trigger to bring users back to the system or game. The system could be configured to email a user, informing them that other users have indicated an interest, thereby motivating the user to log on and play the game.

This process also increases engagement once a user logs in. If a user is not told that he or she had new users who have indicated an interest, he or she would have less urgency to play the game. Additionally, once you play the game, you are inclined to play for longer.

Still further, the process removes some of the stigma associated with online dating, and tends to position the system as a game. This is important to differentiate the system from current online dating services. Additionally, this is important given some prospective user demographics.

The process also provides that the system is configured favorably for valuable interstitial advertising. For example, the system may be configured such that, if a user is going to be presented with user profiles where 7 out of the first 20 profiles to be shown have previously indicated an interest, and the user has looked at the first 10 user profiles, and there remains three left out of the next 10 where the user has previously indicated an interest, the user will be more likely to sit through a video or photograph advertisement before going on to view the remaining profiles.

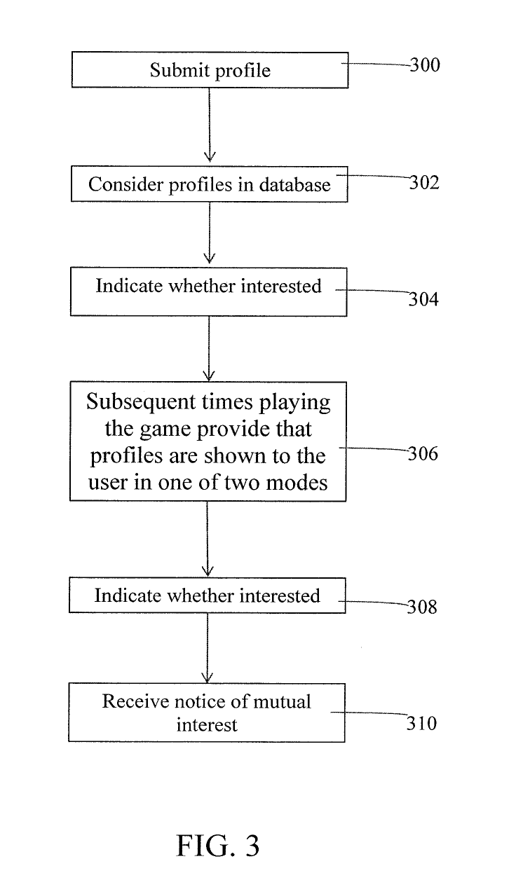

FIG. 3 is similar to FIG. 1, but shows the functionality from a user's perspective. FIG. 3 is self-explanatory in light of FIG. 1 and the description associated therewith, but FIG. 3 will be briefly described. As shown, a user submits a profile relating to him or herself (block 300 in FIG. 3). Then, the user considers profiles relating to other users (block 302 in FIG. 3). The user indicates to the system whether or not he or she is interested in a given person being profiled (such as by clicking “Who's That?” or “Next” as shown in FIG. 2) (block 304 in FIG. 3). Upon logging off and playing the game later, the system preferably operates in one of two modes (block 306 in FIG. 3), as discussed above, depending on whether another user has indicated an interest in the user. In one mode, no other user has indicated an interest in the user since the last time the user has logged on and played the game. In that case, preferably the system is configured to just show the user a plurality of profiles which are all randomly selected. In the other mode, one or more other users have indicated an interest in the user since the last time the user has logged on and played the game. In that case, preferably the system is configured to notify the user that x number of other users have indicated an interest, and that these users' profiles or pictures will be shown in the next y number of profiles shown (where x<y). In this case, within the first y profiles shown, x relate to users who have previously indicated an interest, and the remaining profiles (y-x) are randomly selected. Once y number of profiles are presented to the user, the remaining profiles which are presented to the user are randomly selected by the system. The user indicates to the system whether or not he or she is interested in a given user being displayed (block 308 in FIG. 3). Upon the system determining that two users have indicated an interest in each other, one or preferably both of the users receive a message or some other indication from the system that a mutual interest has been determined by the system (block 310 in FIG. 3).

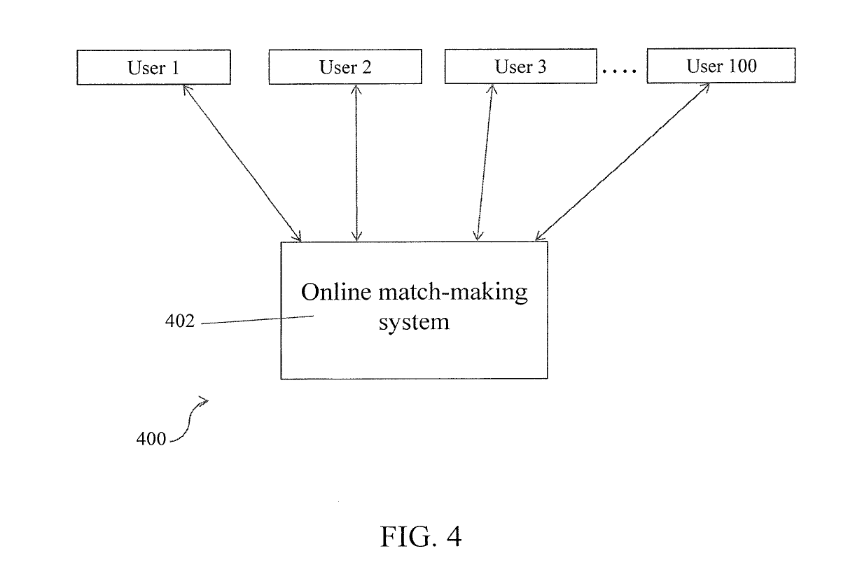

FIG. 4 illustrates the architecture of a user network 400, which includes the match-making system 402 previously described. As an example, one hundred users are shown. Each user can interact with the system 402. This interaction can be facilitated in many ways, all of which are conventional. For example, a user can use an application on a smart phone to interact with the system, or a user can use a computer to interact with the system over the Internet. These are just two examples. The users and the system may be on a computer network, on a plurality of computer networks which interact with each other, etc.

An example of the functionality of the system will now be described with reference to FIG. 4. Assuming users 1 through 100 have previously logged into the system and created profiles, and assuming users 3, 29, 42, 67, 91, 92 and 98 have previously indicated an interest in user 1 (such as by clicking “Who's That?” when user 1's profile was displayed (see FIG. 2)), when user 1 logs into the system to view profiles, the first seven out of twenty profiles shown to user 1 will correspond to users who have previously indicated an interest in user 1. If user 1 indicates an interest in any of the users who have previously indicated an interest in user 1, the system sends a message to one or preferably both users informing them of the mutual interest, or otherwise promotes contact between the two users.

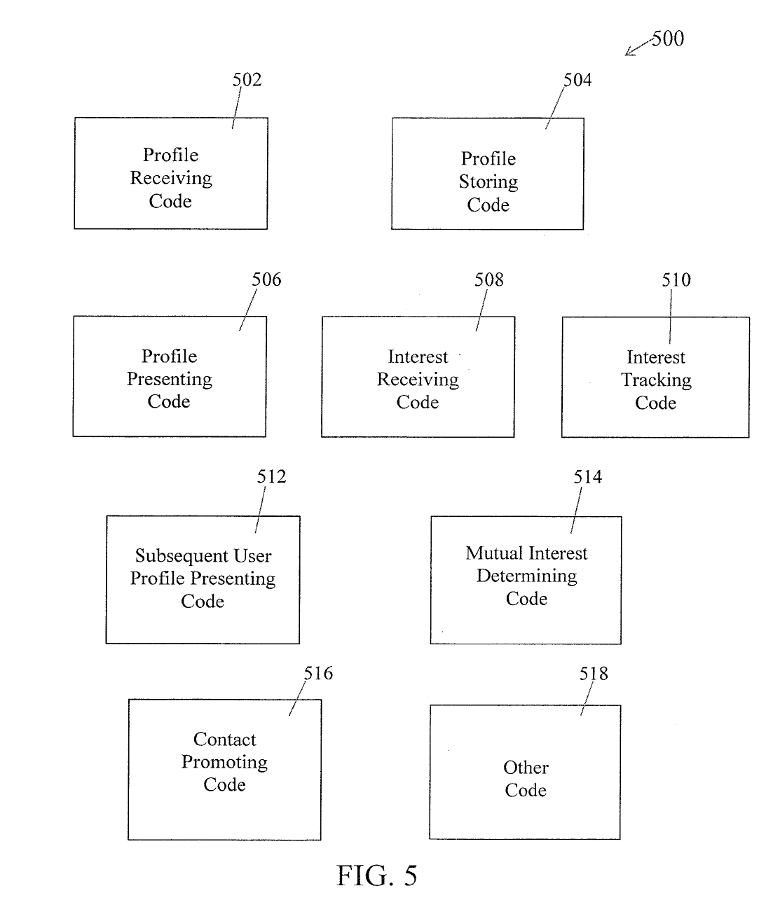

FIG. 5 illustrates computer readable code 500 which is configured for use by one or more computers or one or more computer networks, etc., to provide the online match-making system previously described. It must be understood that the term “computer” is used very broadly herein, and is meant to cover smartphones, tablets, etc. As such, the invention can take the form of a smartphone application.

As shown in FIG. 5, the code includes code configured to receive profiles 502, code configured to store the profiles in a database 504, code configured to present a user with a plurality of profiles for consideration 506, code configured to receive from the user an indication of whether or not the user has an interest with regard to each of the profiles being considered 508, code configured to keep track of instances where the user has indicated an interest in a given profile 510, code configured to present a subsequent user with a plurality of profiles for consideration wherein a pre-determined proportion of the plurality of profiles which are presented to the subsequent user correspond to other users who have previously indicated an interest in the subsequent user 512 (this code 512 preferably includes code which provides that the system operates in one of two modes, discussed above, depending on whether other users have indicated an interest in the user since the user last played the game, and is preferably configured to inform the user that x number of users out of the next y profiles to be shown to the user have previously indicated an interest in the user), code configured to determine whether there exists mutual interest between users based on what the users have communicated to the system regarding profiles which were considered by the users 514, and code configured to inform at least one of the users or preferably both of the users that there is a mutual interest 516. Still other code 518 is employed to provide still other functionality of the system, such as code for managing log in information, etc.

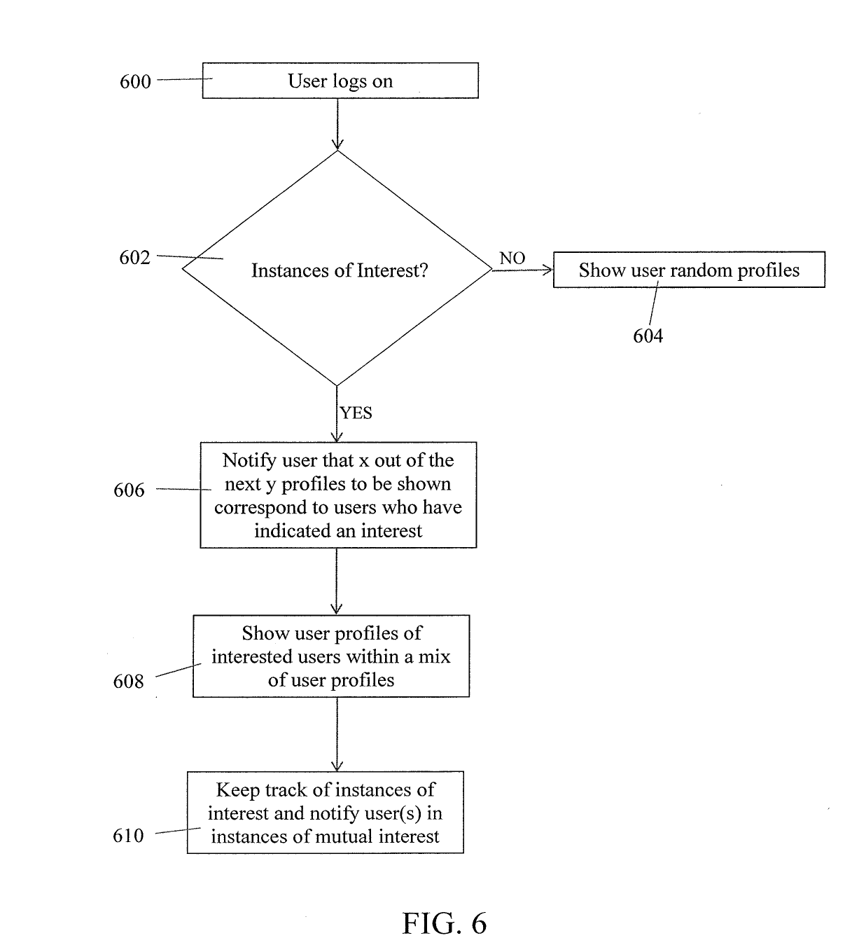

As discussed above, the system (and the code which is configured to provide same) is preferably configured to operate in two modes for a given user, depending on whether any other users have indicated an interest in that user. The two modes can readily be seen in FIG. 6. As shown, the user logs into the system (block 600 in FIG. 6). If no other users have indicated an interest in that user, the user is shown random profiles (blocks 602 and 604 in FIG. 6). This is one mode of operation. In contrast, if any other users have previously indicated an interest in the user, the system informs the user how many users have indicated an interest, and informs the user that the profiles relating to those users who have indicated an interest will be shown to the user in a mix of a number of profiles (blocks 602 and 606 in FIG. 6). For example, if seven users have indicated an interest, the system may inform the user that seven users have indicated an interest and they will now be displayed within the next twenty profiles. As the user views the profiles (block 608 in FIG. 6), the user can indicate an interest in the users associated with the profiles. The system keeps track of instances of interest, and in instances of mutual interest, the system notifies one or preferably both users of the mutual interest (block 610 in FIG. 6).

While two modes of operation are discussed, the system (and code configured to provide same) may be configured to operate in many more modes than just two, or may be configured to operate in modes which vary from the two modes which have been described. For example, the system could be configured to first show a user a certain number of random profiles before informing the user how many users have previously indicated an interest. Thereafter, the system can operate in the second mode previously described (see blocks 606, 608 and 610 of FIG. 6 and associated description, above).

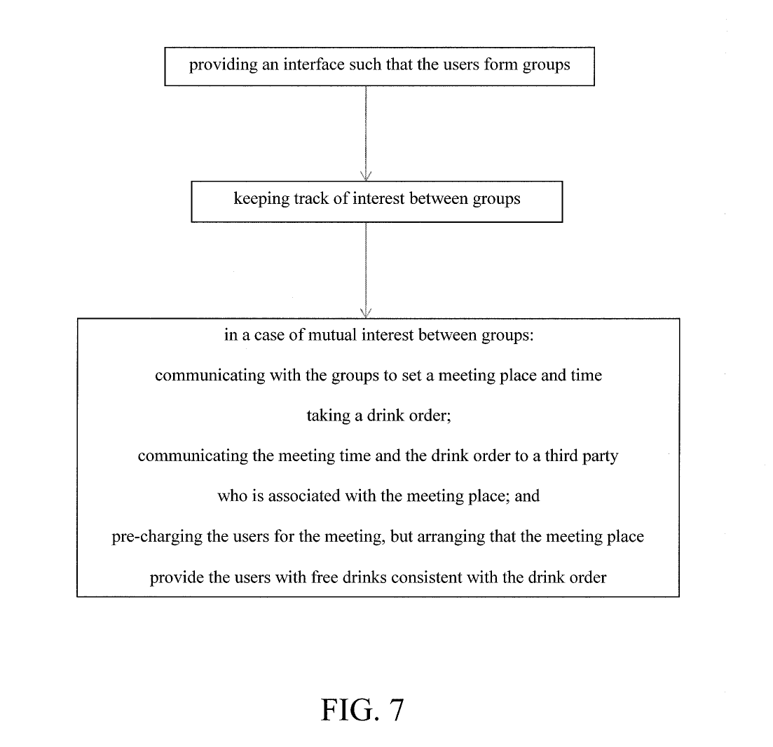

The system may also be configured to operate in group mode, as shown in FIG. 7. In group mode, the system provides an interface such that user can invite or select other users to join in a group (i.e., Group A). Thereafter, as the users of Group A play the match-making game, and as they indicate interest in other users, the system keeps track of whether any user in a first group (i.e., Group A) has indicated an interest in any user in a second group (i.e., Group B), and if so, the system informs the users of both groups of the mutual interest between the groups. The system is preferably configured to query at least one of the groups to select a meeting place and time, and communicates the meeting place and time to the other group for approval. Preferably, the system is configured to take a drink order of the users of at least one of the groups and communicate the meeting time and the drink order to a third party who is associated with the meeting place. The system is also preferably configured to pre-charge the users for the meeting, but then arrangement is made with the meeting place so that the users are provided with free drinks consistent with the drink order. Of course, the group mode may operate in many other ways, while still staying within the scope of the present invention.

While specific embodiments of the present invention have been shown and described, it is envisioned that those skilled in the art may devise various modifications without departing from the spirit and scope of the present invention.

What is claimed is:

1. An online match-making method comprising:
receiving profiles from users;
maintaining a database of the profiles which are received;
showing users different profiles and querying users regarding interest;
keeping track of interest indicated by users; and
informing users of mutual interest.

2. The online match-making method as recited in claim 1, wherein each profile includes at least a picture of the user corresponding to the profile.

3. The online match-making method as recited in claim 1, wherein the step of showing users different profiles and querying users regarding interest comprises showing users a first set of profiles, wherein a pre-determined proportion of the first set of profiles correspond to users who have previously indicated an interest in that user.

4. The online match-making method as recited in claim 3, wherein the step of showing users different profiles and querying users regarding interest comprises showing users a first set of profiles, wherein a pre-determined proportion of the first set of profiles correspond to users who have previously indicated an interest in that user, and informing the user that other users have indicated an interest and advising that given user of the proportion either before or while the first set of profiles is shown.

5. The online match-making method as recited in claim 1, wherein the step of informing users of mutual interest comprises sending each user a message informing that user that another user has indicated interest.

6. The online match-making method as recited in claim 1, wherein:
if no other users have indicated in an interest in a given user, showing that given user random profiles of other users; and
if other users have indicated in an interest in the given user, showing that given user a first set of profiles, wherein a pre-determined proportion of the first set of profiles correspond to users who have previously indicated an interest in that given user.

7. The online match-making method as recited in claim 6, wherein the step of showing that given user a first set of profiles further comprises informing that given user that other users have indicated an interest and advising that given user of the proportion either before or while the first set of profiles is shown.

8. The online match-making method as recited in claim 7, further comprising showing the user one or more advertisements after informing the user that other users have indicated an interest, but before showing the user the first set of profiles.

9. The online match-making method as recited in claim 1, further comprising allowing a given user to view other users' profiles only if that given user has already submitted a profile.

10. The online match-making method as recited in claim 1, wherein the step of querying users regarding interest comprises presenting the user with two buttons to click, wherein one button represents interest and another button represents no interest.

11. The online match-making method as recited in claim 1, further comprising providing an interface such that the users form groups, keeping track of whether any user in a first group has indicated an interest in any user in a second group, and if so, sending the users of both groups an indication of mutual interest between the groups.

12. The online match-making method as recited in claim 11, further comprising querying at least one of the groups to select a meeting place and time, and communicating the meeting place and time to the other group for approval.

13. The online match-making method as recited in claim 12, further comprising taking a drink order of the users of at least one of the groups and communicating the meeting time and the drink order to a third party who is associated with the meeting place.

14. The online match-making method as recited in claim 13, further comprising pre-charging the users for the meeting, but arranging such that the users are presented with free drinks at the meeting place consistent with the drink order.
